(19) United States
(12) Patent Application Publication
(10) Pub. No.: US 2024/0320503 A1
(43) Pub. Date: Sep. 26, 2024

(54) EXPLAINING NEURO-SYMBOLIC REINFORCEMENT LEARNING REASONING

(71) Applicant: International Business Machines Corporation, Armonk, NY (US)

(72) Inventors: Daiki Kimura, Midori-ku (JP); Stefan Zecevic, Santa Clara, CA (US); SUBHAJIT CHAUDHURY, White Plains, NY (US); Michiaki Tatsubori, Oiso (JP)

(21) Appl. No.: 18/187,018

(22) Filed: Mar. 21, 2023

(51) Int. Cl. G06N 3/092; G06N 3/042

(52) U.S. Cl. CPC G06N 3/092; G06N 3/042

(57) ABSTRACT

Examples described herein provide a method for explaining neuro-symbolic reinforcement learning reasoning in a neuro-symbolic neural network for neuro-symbolic artificial intelligence. The method includes selecting an action from among possible candidates taken in an environment, wherein the action comprises a pair of a verb and an entity and displaying one or more logical facts that are extracted from natural observation sentences of the environment. The method also includes visualizing contrastive information for a current state and a goal state which is from external knowledge and displaying trained rules in the neuro-symbolic neural network for neuro-symbolic artificial intelligence, wherein, in response to a first user selection of the action, highlighting each pair of the verb and the entity and a fired predicate corresponding to the first user selection.

### BACKGROUND

Embodiments described herein generally relate to processing systems for artificial intelligence, and more specifically, to explaining neuro-symbolic reinforcement learning reasoning.

Machine learning is a form of artificial intelligence that broadly describes a function of electronic systems that learn from data. Data, known as training data, is introduced to a mathematical algorithm, and parameters of the mathematical algorithm are adjusted based on the training data to learn functional relationships between inputs and outputs. One type of machine learning is neuro-symbolic reinforcement learning, which is an approach to machine learning that combines symbolic reasoning with neural networks to solve complex problems through trial and error.

### SUMMARY

In one exemplary embodiment, a system for explaining neuro-symbolic reinforcement learning reasoning in a neuro-symbolic neural network for neuro-symbolic artificial intelligence is provided. The system includes A system for explaining neuro-symbolic reinforcement learning reasoning in a neuro-symbolic neural network for neuro-symbolic artificial intelligence. The system includes an action selector for selecting an action from possible candidates taken in an environment, wherein the action comprises a pair of a verb and an entity and a current state fact visualizer for showing one or more logical facts that are extracted from natural observation sentences of the environment. The system also includes a contrastive external knowledge visualizer for visualizing contrastive information for a current state and a goal state which is from external knowledge and a trained rules analyzer for showing trained rules in the neuro-symbolic neural network for neuro-symbolic artificial intelligence. In response to a first user selection of the action by using the action selector, the current state fact visualizer, the contrastive external knowledge visualizer, and the trained rules analyzer highlights each pair of the verb and the entity and a fired predicate corresponding to the first user selection.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a processing system for implementing one or more embodiments described herein;

FIG. 2 depicts a human-in-the-loop system according to one or more embodiments described herein;

FIG. 3 depicts a block diagram of a processing system that includes engines to facilitate explaining neuro-symbolic reinforcement learning reasoning according to one or more embodiments described herein;

FIG. 4 depicts an interactive interface for gameplay according to one or more embodiments described herein;

FIGS. 5A, 5B, 5C, 5D, and 5E together depict an interactive user interface for understanding a neuro-symbolic model according to one or more embodiments described herein;

FIGS. 6A and 6B depict interfaces for deleting or adding nodes, respectively, from a network according to one or more embodiments described herein; and

FIGS. 7A, 7B, and 7C depict tables showing evaluation results according to one or more embodiments described herein.

The diagrams depicted herein are illustrative. There can be many variations to the diagram or the operations described therein without departing from the scope of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the described herein provide for explaining neuro-symbolic reinforcement learning reasoning.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as explaining neuro-symbolic reinforcement learning reasoning 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

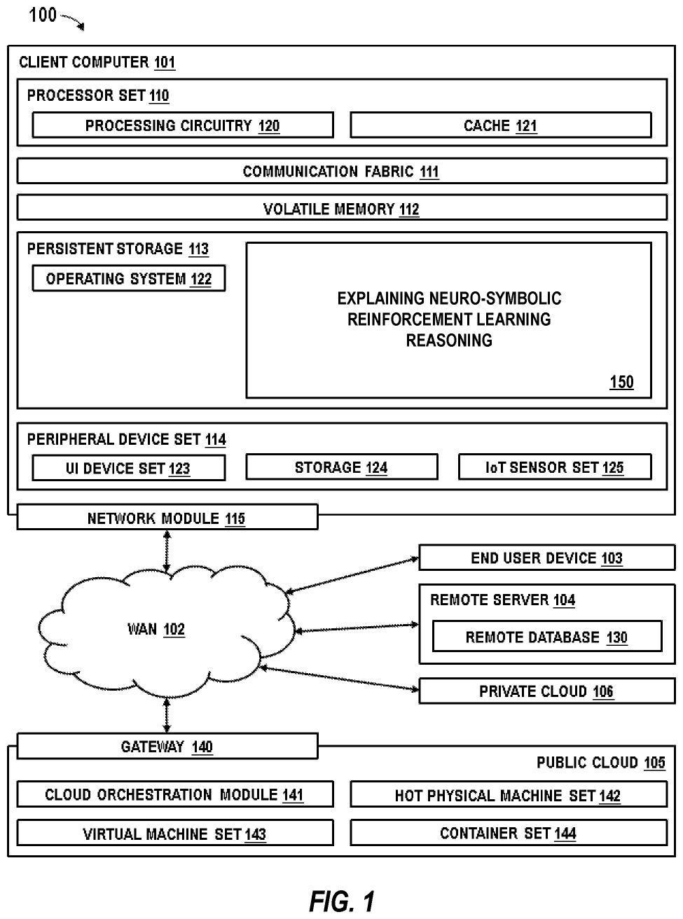

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein relate to neuro-symbolic reinforcement learning, which is an approach to machine learning that combines symbolic reasoning with neural networks to solve complex problems through trial and error. Trained machine learning models often serve as “black boxes” in that such models are often not transparent. It may be unclear, for example, why a trained model made certain decisions. A lack of transparency in trained machine learning models is a concern for their use in enterprise settings. Recently, neuro-symbolic methods have been proposed to increase transparency. Although these approaches can show trained rules in neuro-symbolic neural networks, such approaches remain unclear regarding understand the reasons for the model's decision, and a human operator cannot edit the trained knowledge since there is no graphical visualizer and easy-to-use interface. One or more embodiments described herein provide for explaining neuro-symbolic reinforcement learning reasoning. According to an embodiment, a graphical interface for neuro-symbolic reinforcement learning is provided.

Deep learning has been successfully demonstrated in many applications, and reinforcement learning, which trains how intelligent agents ought to take actions in an environment, is one such application. Conventional approaches implement many training trials for converging to an optimal action policy, and the trained action policy is often not understandable for a human operator. This is because the trained policy is stored in a black-box deep neural network. In enterprise use-cases, the black-box nature of the trained model proves problematic where a human operator wants to verify the trained rules but cannot. To overcome this black-box problem, neuro-symbolic artificial intelligence (neuro-symbolic AI) can be used to addresses the gaps remaining between deep methods and general artificial intelligence. In particular, neuro-symbolic AI is aimed at augmenting the strengths of statistical AI by machine learning with the complementary capabilities of symbolic AI. Neuro-symbolic AI provides the capabilities to: solve difficult problems, learn with less data, and provide understandable and controllable decisions.

Conventional approach to neuro-symbolic AI focus on increasing accuracy and displaying the trained rules after the training. However, the human operator cannot interact to edit the trained rules. Further, such approaches fail to provide for explaining neuro-symbolic reinforcement learning reasoning.

In an effort to cure these and other shortcomings, one or more embodiments described herein provide for explaining neuro-symbolic reinforcement learning reasoning. One or more embodiments provide a “human-in-the-loop” approach. One or more embodiments described herein can address one or more of the following: realizing explaining neuro-symbolic reinforcement learning reasoning, the advantages of a human operator updating the rules in neuro-symbolic AI after machine training, and the effectiveness of setting initial rules before the training for boosting the training.

One or more embodiments described herein may provide multiple causes behind each decision that is made using a neuro-symbolic AI to improve the sense of understanding. For example, extracted logical facts and symbolic rules for a decision-making process can be shown since the neuro-symbolic AI obtains logical facts from raw input sentences and symbolic rules from training examples. Further, reasoning can come from contrastive information and importance of the contrastive information can also be pointed out in the AI field. For example, one or more embodiments described herein shows the differences between current state information and goal state information that is from external knowledge as contrastive information in a reinforcement learning setting.

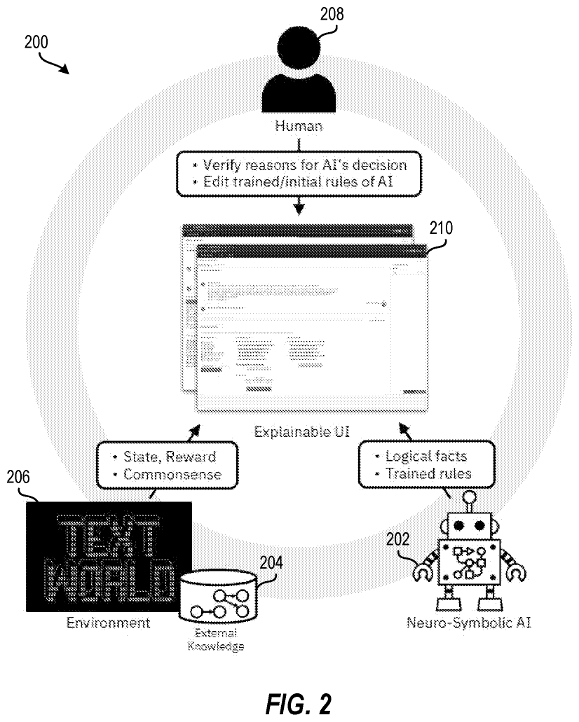

Turning now to FIG. 2, a human-in-the-loop system 200 is shown according to one or more embodiments described herein. This example considers the use-case of realizing an explainable system for a reinforcement learning method of text-based games in order to deal with various challenging research problems, but the embodiments described herein are not so limited. The reasons a text-based game example is used is there is a method for converting logical fact from natural language and some studies demonstrated advantages in terms of quick training and visualizing of the trained rules with text-based games. In the example of FIG. 2, an explainable user interface (UI) 210 presents information from an environment 206 (e.g., the text-based game) and a neuro-symbolic AI 202 to a user 208 to enable a user to understand neuro-symbolic reinforcement learning reasoning. The human 208 can verify the reasons for the decision of the neuro-symbolic 202 and can edit the trained rules. Particularly, the system 200 includes the neuro-symbolic AI 202, which provides logical facts and trained rules to the explainable UI 210. The system 200 further includes external knowledge 204 of the environment 206, which provides a state, reward, and commonsense to the explainable UI 210. The system 200 provides for the human 208 to verify reasons for the decision of the neuro-symbolic AI 202 using the explainable UI 210 and provides the ability for the human 208 to edit rules of the neuro-symbolic AI 202 using the explainable UI 210.

Moreover, the system 200 provides for two use-case scenarios involving an interactive demo: one involves the human 208 updating trained rules after training to increase test score values, and the other involves the human 208 setting initial rules before training to boost the training. Additionally or alternatively, accuracy ratios for with or without the explainable UI 210 are surveyed, and a questionnaire for satisfaction ratios of the proposed system compared to naïve text style interface are provided.

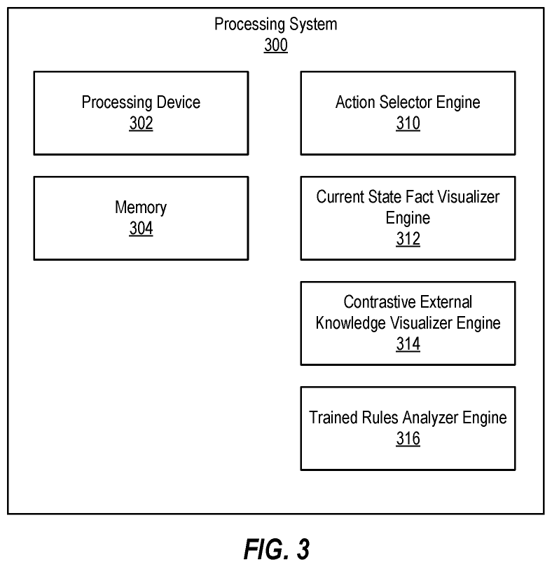

FIG. 3 depicts a block diagram of a processing system 300 (or simply “system”) that includes engines to facilitate explaining neuro-symbolic reinforcement learning reasoning, which the human operator is in a training loop of the system, as shown in FIG. 2, for example. In particular, the processing system 300 includes a processing device 302, a memory 304, an action selector engine 310, a current state fact visualizer engine 312, a contrastive external knowledge visualizer engine 314, and a trained rules analyzer engine 316. These engines are now described in more detail using a text-based game example but are not so limiting.

The various components, modules, engines, etc. described regarding FIG. 3 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) (e.g., the engines 310, 312, 314, 316) described herein can be a combination of hardware and programming. The programming can be processor executable instructions stored on a tangible memory, and the hardware can include the processing device 302 for executing those instructions. Thus a system memory (e.g., memory 304) can store program instructions that when executed by the processing device 302 implement the engines described herein. Other engines can also be utilized to include other features and functionality described in other examples herein.

The action selector engine 310 provides for choosing attention of pairs of target verb and entities. More specifically, the action selector engine 310 provides for selecting an action from among candidates. A human operator (e.g., the human 208) chooses a target action for the explainable UI 210. When the human 208 selects an action, the processing system 300 highlights relevant current facts and external information relevant to entities for the selected action, and rules that are relevant to a verb in the action. The action selector engine 310 can give attention on the basis of human preference of the human 208.

The current state fact visualizer engine 312 provides for showing current logical facts for understanding extracted facts by using a semantic parser from raw natural sentences. The current state fact visualizer engine 312 can show the current situation to the human 208. The entities of the selected action can be highlighted as words to be notified to the human operator, and the facts can be sorted by relevancy to the action for each fact.

The contrastive external knowledge visualizer engine 314 provides for visualizing contrasting information for a current state and a goal state from the external knowledge 204. For example, commonsense information is a candidate for contrastive goal information against the current state. The contrastive external knowledge visualizer engine 314 highlights the relevant entities for the selected action. The human 208 can understand the difference between the current state and goal and then can understand a reason for the action by the agent. The contrastive external knowledge visualizer engine 314 can show the goal to the human 208.

The trained rules analyzer engine 316 provides for visualizing and editing neuro-symbolic AI rules. The trained rules analyzer engine 316 provides for the human 208 to interact with the neuro-symbolic AI rules. For example, the trained rules analyzer engine 316 can highlight activated/fired nodes for the human 208 to view when the input action is selected.

With continued reference to the components of FIGS. 2 and 3, an example using text-based games is now further described to demonstrate explaining neuro-symbolic reinforcement learning reasoning using, for example, the processing system 300.

Text-based games are categorized as partially observable Markov decision processes (POMDPs), which are a generalization of the Markov decision process, and they are represented as a 7-tuple of (S, A, T, R, Ω, O, γ) denoting a set of environment states, actions, conditional transition probabilities between states, reward functions, observations, conditional observation probabilities, and discount factors. In this paper, we use choice-based games, where the agent receives a natural textual observation oₜ ∈Ω and returns a short textual phrase from among action choices A to the environment as an action aₜ; then, it receives the next observation Oₜ₊₁ ∈Ω and reward value rₜ ∈R. The obtained observation oₜ does not contain the entire information of the current state sₜ ∈S. The goal for the agent is to maximize the expected future discounted reward by choosing suitable actions at each time step: E|Eₜ₌₀^{∞}Y^{t}rₜ|, where rₜ is the reward earned at time t.

Experiments using the TextWorld Commonsense (TWC) game verify the explainability of the processing system 300 for explaining neuro-symbolic reinforcement learning reasoning using for example. The TWC game is a text-based game that uses the TextWorld framework and leverages commonsense knowledge from ConceptNet graphs. Commonsense knowledge is stored as triplets of (relationship, subject, object). An agent introduces commonsense knowledge into a reinforcement learning method for giving goal information. The commonsense information can be used as contrastive external information against the current state. A goal of the TWC game is to clean up a room by putting an object where it should be on the basis of commonsense knowledge on the relationships between an object and its location. For example, a used tissue might be placed in a pedal bin or wastepaper basket, and clean white socks might be placed in a chest of drawers. The TWC game has three difficulty levels depending on the number of rooms and the number of interactive objects, as shown in Table 1, and the processing system 300 can support each of the levels.

TABLE 1
Specifications of TWC game

| Level | # of Objects | # of Rooms |
|---|---|---|
| Easy | 1 | 1 |
| Medium | 2, 3 | 1 |
| Hard | 6, 7 | 1, 2 |

For the purposes of simplicity of explanation, the consider the easy level for the following explanations and survey to users for easy understanding of the problem settings and environment. However, the medium level is used to explain the following experiments for use-case scenarios involving the editing function because the neuro-symbolic agent can easily solve the easy level (e.g., the neuro-symbolic agent obtains an almost perfect score already), so it is difficult to show an improvement in the test score with the easy level. However, the hard level has varying difficulty as the room layouts can change, which interferes with the comparison.

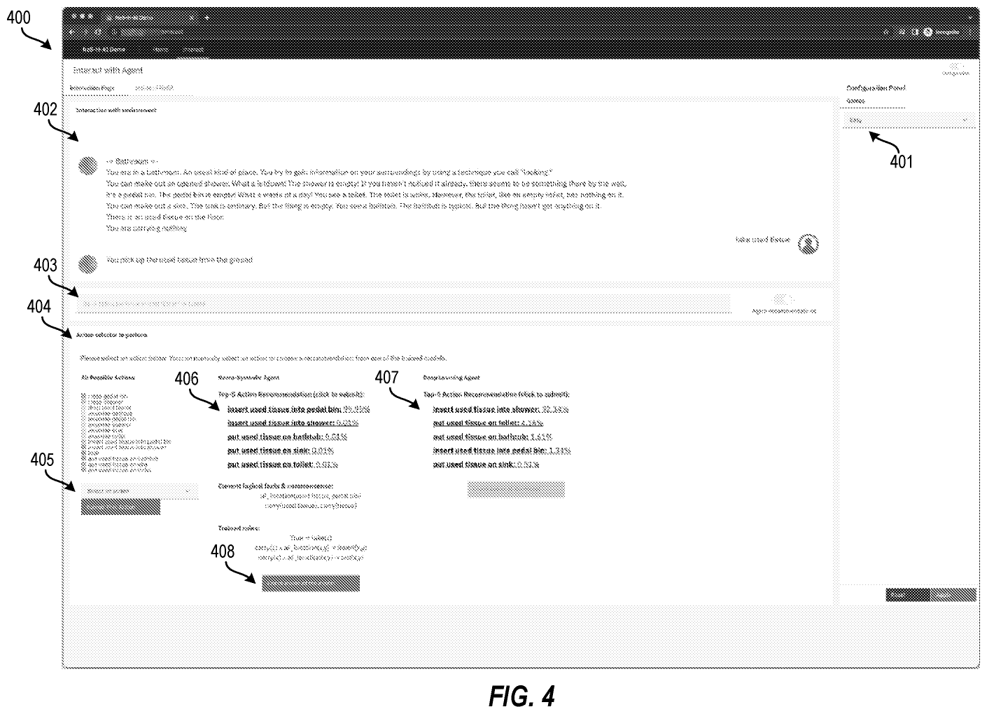

Turning now to FIG. 4, an example of an interactive interface 400 for gameplay according to one or more embodiments described herein. In this example, a human user (e.g., the human 208) can select an action from possible actions and recommended action list from a neuro-symbolic agenda and a deep learning agent, as shown. The interface 400 includes a configuration panel 401 for selecting the difficulty level (e.g., “easy”). The interface 400 also includes an interaction history panel 402, a text box field 403 for manual action input, and results 404 from a neuro-symbolic agent and a deep learning agent. The interaction history panel 402 displays the conversation history between the environment and the agent that is controlled by the human player. In this example, the environment first prompted, “-=Bathroom=-You are in a bathroom. A usual kind of place. You try to gain information on your surroundings. . . . There is a used tissue on the floor. You are carrying nothing.” These sentences were displayed to the human player as initial observation sentences. Subsequently, the human player returned “take used tissue”; after that, the environment said “You pick up the used tissue from the ground” as the second observation. Now, the environment is waiting for the next action from the human player.

The text box field 403, which displays “input action sentence and hit ‘enter’ to submit”, is used for manually interacting with environment by the human operator. The operator can input an arbitrary action, for example.

The results 404, labeled “action selector to perform” box, is for selecting an action to send to the environment and has three areas: (i) a field 405 for manually selecting an action from possible actions, (ii) a selection field 406 where actions in the list are clickable for, for example, top-5 recommended actions from a trained neuro-symbolic agent, and (iii) a selection field 407 where actions in the list are clickable for, for example, top-5 recommended actions from a trained deep learning agent. The neuro-symbolic agent is an agent extended from first-order logic logical neural network (FOL-LNN) to this game and adapted commonsense input. In this example, the neuro-symbolic agent recommends taking the action of “insert used tissue into pedal bin” with 99.95% likelihood, and the deep learning agent recommends taking “insert used tissue into shower” with 92.34%. Since the agent is currently holding the used tissue, which is observed from the last message from the environment, and the used tissue is to be placed in a pedal bin, “insert used tissue into pedal bin” is the suitable action in this situation. The reason the deep learning method recommends a different action is that the agent still needs a large amount of data to train the policy. On the other hand, the neuro-symbolic agent can train from smaller data by an advantage of neuro-symbolic AI. From this interactive interface, the human 208 can understand the advantage of neuro-symbolic AI by looking at the difference between these recommendations from both agents (selection field 406 compared to selection field 407).

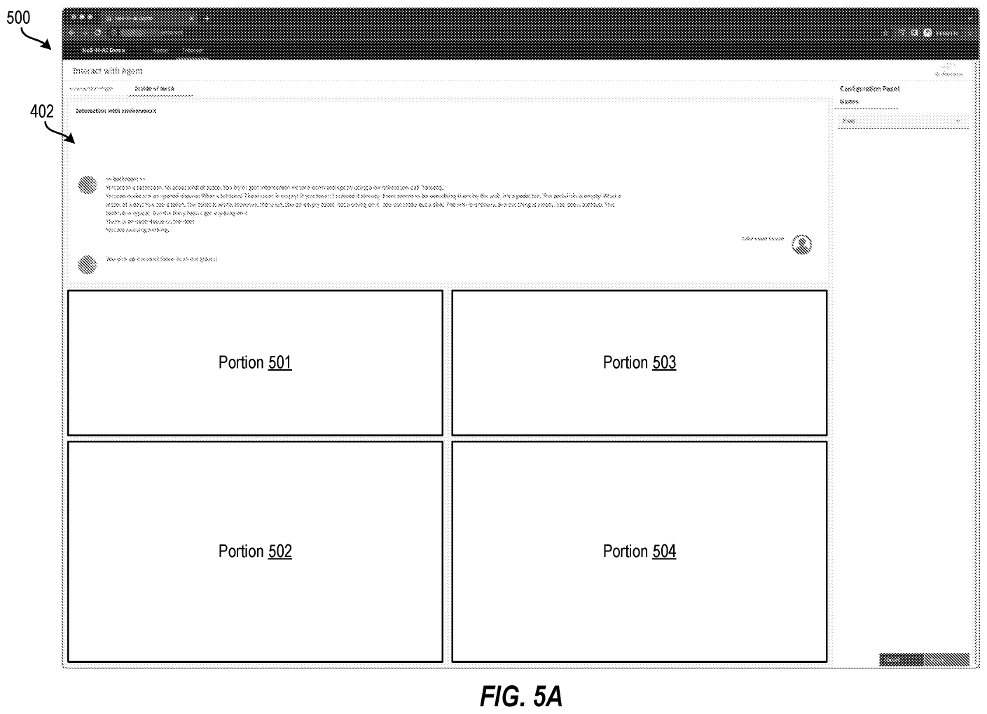

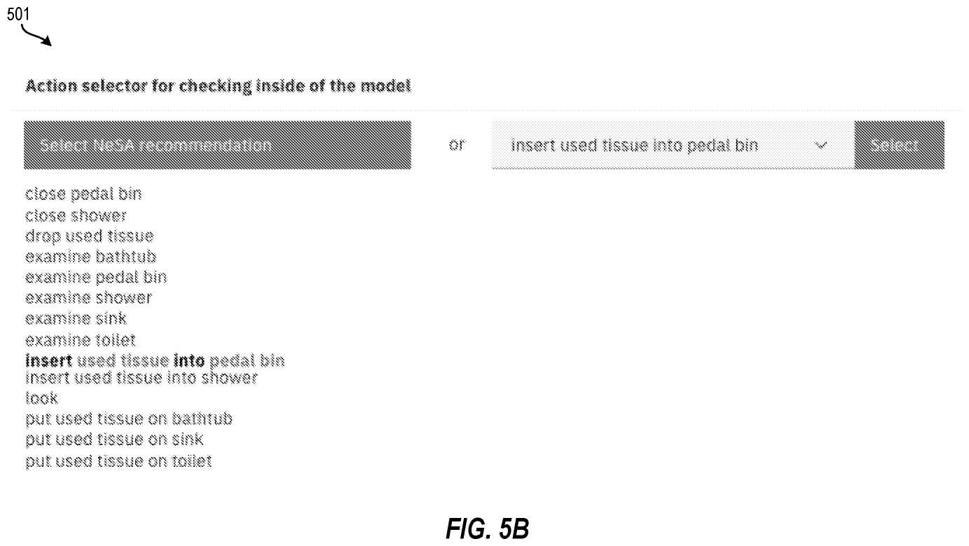

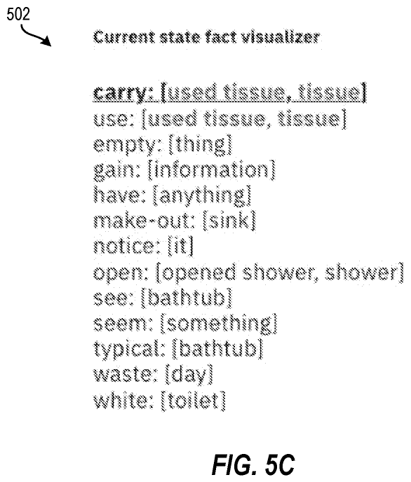

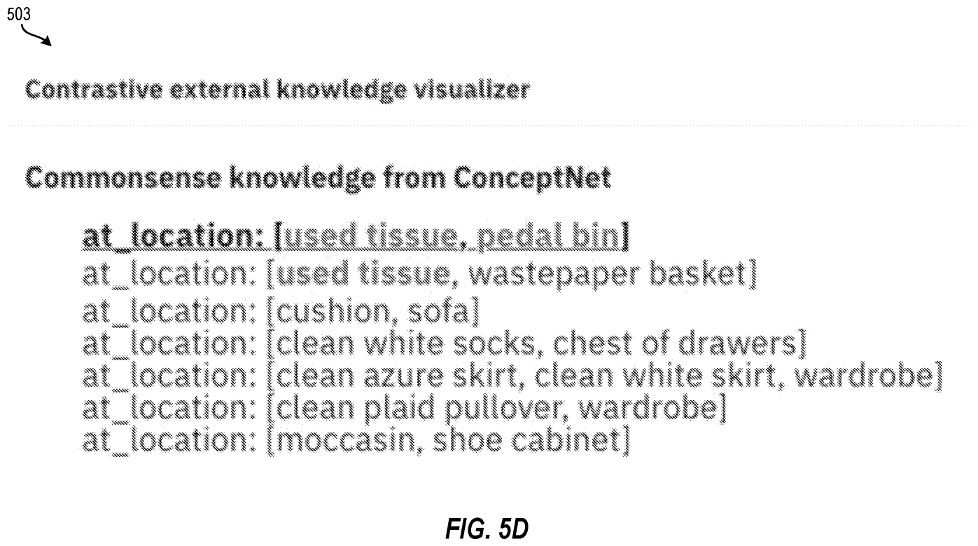

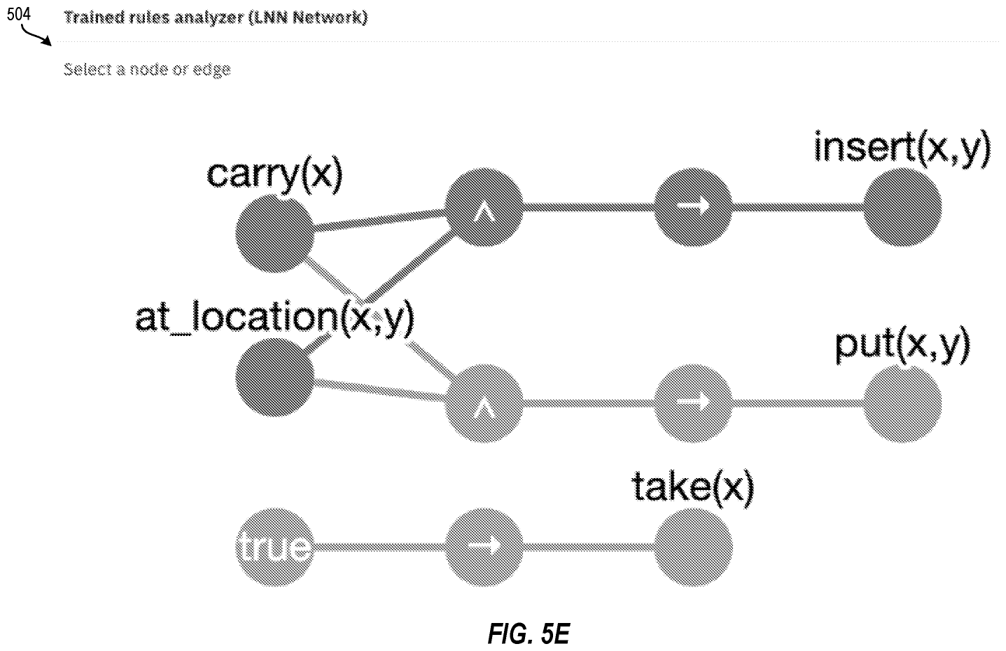

Further, a visualization field for current logical facts, commonsense, and trained rules, is displayed in the neuro-symbolic agent (e.g., under the action list in the “Neuro-Symbolic Agent” column). The deep learning agent does not display this type of information because the deep learning model does not have explainability. In this example, the neuro-symbolic agent indicates that there are “at_location(used tissue, pedal bin),” “carry(used tissue),” and “carry(tissue)” in current facts or commonsense, and three rules, e.g., “carry(x) A at_location(x, y)→insert(x, y).” However, it can be assumed that this text-based user interface, for those types of information, is hard to understand the reasons for a recommended action. In an effort to improve this shortcoming, one or more embodiments provide a text style viewer for comparison, as shown in FIGS. 5A-5E.

Now described is an explainable UI for understanding the neuro-symbolic model. Particularly, FIG. 5A depicts an interactive explainable UI 500 for explaining neuro-symbolic reinforcement learning reasoning according to one or more embodiments described herein. FIGS. 5B, 5C, 5D, and 5E depict portions 501, 502, 503, 504, of the interactive explainable UI 500 as further described herein. In this example, the interactive explainable UI 500 provides for a human operator (e.g., the human 208) to view the reasoning of the neuro-symbolic agent using the components of the processing system 300, for example.

The interactive explainable UI 500 appears, for example, when the “check inside the model” option 408 is selected on the interface 400. The interactive explainable UI 500 of includes the interaction history panel 402. The interactive explainable UI 500 also includes four portions 501-504 that correspond to the engines 310, 312, 314, 316 of FIG. 3, and the four portions 501-504 are shown in more detail in FIGS. 5B-5D, respectively. Particularly, FIG. 5B depicts the portion 501, which is an action selector for checking inside the neuro-symbolic AI model (e.g., generated using the engine 310). FIG. 5C depicts the portion 502, which is a current state fact visualizer (e.g., generated using the engine 312). FIG. 5D depicts the portion 503, which is a contrastive external knowledge visualizer (e.g., generated using the engine 314). FIG. 5E depicts the portion 504, which is a trained rules analyzer (e.g., generated using the engine 316).

The example of FIGS. 5A-5E shows that the human 208 is selecting the “insert used tissue into pedal bin” action in the “action selector for checking inside of the model” box. Since the human 208 selects the “insert used tissue into pedal bin” action, the verb “insert” and entities “used tissue” and “pedal bin” are highlighted in portions 502, 503, as shown. More specifically, “carry: [used tissue, tissue]” and “use: [used tissue, tissue]” in the current state fact visualizer (FIG. 5C), and “at_location [used tissue, pedal bin]” in the contrastive external knowledge visualizer (FIG. 5D) are highlighted. Each entity can be differentiated by a different indicium; for example, each entity can have a different color. As an example, “used tissue” can appear blue, and “pedal bin” can appear green. According to one or more embodiments described herein, logical facts and entities from the action are extracted from given raw natural language sentences by the transition-based parser for abstract meaning representation (AMR). The processing system 300 automatically extracts verb and entities by AMR. The relationship information for commonsense knowledge is extracted from ConceptNet.

With continued reference to FIGS. 5A-5E, the trained rule “carry(x) A at_location(x, y)→insert(x, y)” is also highlighted (FIG. 5E) in the trained rules analyzer, and the reasoning for this rule is then provided. The formula “insert(x, y)” represents an action, “insert x into y,” where x and y are variables; in this example, the selected action is “insert used tissue into pedal bin” and then x=“used tissue” and y=“pedal bin.” Then, the formula “carry(x)” means “carry(used tissue),” which represents whether the agent carries the used tissue. Since there is the fact “carry: [used tissue]” in the current state fact visualizer (FIG. 5C) because the environment indicated “you pick up the used tissue from the ground” previously, “carry(used tissue)=carry(x)” is activated (FIG. 5E). Also, the formula “at_location(x, y)” means “at_location(used tissue, pedal bin),” which represents whether the used tissue is to be placed into the pedal bin. Since there is the commonsense knowledge “at_location: [used tissue, pedal bin]” in the contrastive external knowledge visualizer (FIG. 5D), “at_location(used tissue, pedal bin)=at_location(x, y)” is activated (FIG. 5E). Therefore, “carry(x)” and “at_location(x, y)” are activated in the trained rules analyzer (FIG. 5E) (underlining for “carry: [used tissue, tissue]” and “at_location: [used tissue, pedal bin]” in the current state fact and commonsense visualizers means activation in rules), the “and (A)” node and the “imply (→)” node are activated by these logical function rules, and then “insert(x, y)” is activated, which means that the agent recommends taking the “insert(x, y)” action, that is, “insert used tissue into pedal bin.” This is how reasons are explained by using the interactive explainable UI 500 for explaining neuro-symbolic reinforcement learning reasoning.

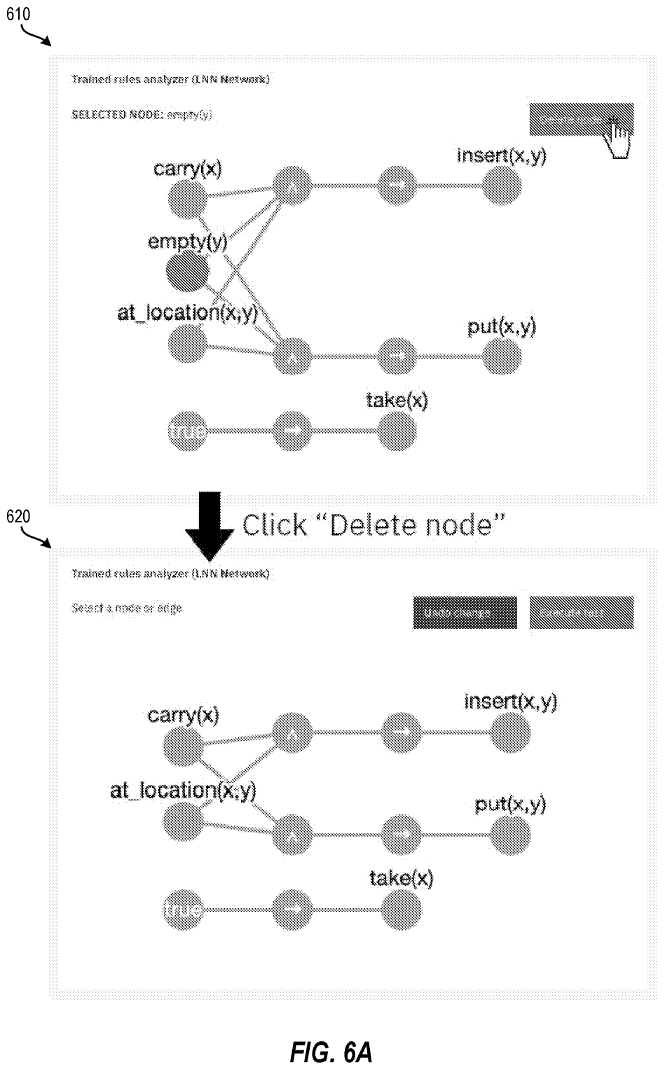

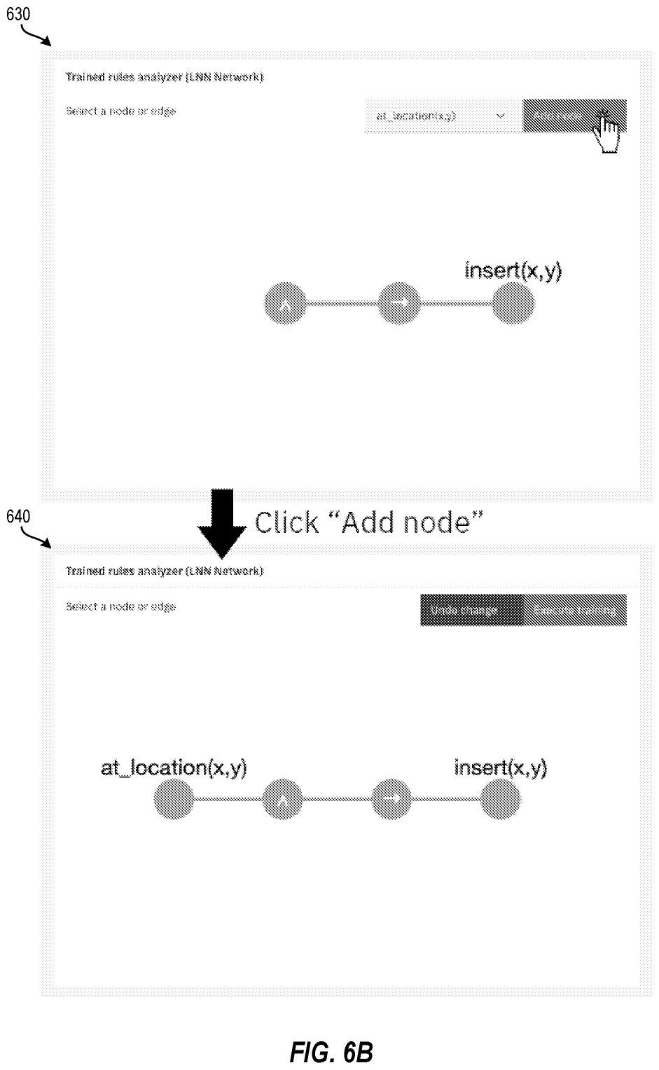

One or more embodiments described herein provide for editing a trained network using the trained rules analyzer engine 316. For example, FIG. 6A depicts interactive interfaces 610, 620 for deleting a node in the trained network according to one or more embodiments described herein. FIG. 6B depicts interactive interfaces 630, 640 for adding a node in an initial network according to one or more embodiments described herein.

For the use-case of deleting the node (FIG. 6A), the human 208 wants to refine the network. As an example, when the human 208 thinks “empty(y)” is not required for “insert” and “put” actions, the human 208 can perform deletion as follows. First (as shown in the interactive interface 610), the human 208 selects a node, and then the selected node is highlighted as shown (e.g., using a color). Next (as shown in the interactive interface 610), the user 208 selects the “delete node” button, and then the selected node and associated edges connected to this node are deleted (as shown in the interactive interface 620). The interactive explainable UI 500 also provides for undoing changes by remembering the history of the network.

For the use-case of adding a node (FIG. 6B), the human the human gives a hint before training. As an example, when the human 208 thinks “at_location(x, y)” should be added for the “insert” action, the human 208 can add this predicate as follows. First (as shown in the interactive interface 630), the human 208 selects a verb in the action selector. Next (as shown in the interactive interface 630), the human 208 selects a predicate from a drop-down box that has multiple predicate candidates in facts and commonsense. Finally (as shown in the interactive interface 630), the human 208 selects the “add node” button, at which point the node is added as an input node of the rule (as shown in the interactive interface 640).

According to one or more embodiments described herein, quantitative assessments on editing a network can be performed for editing a network after training and for editing a network before training.

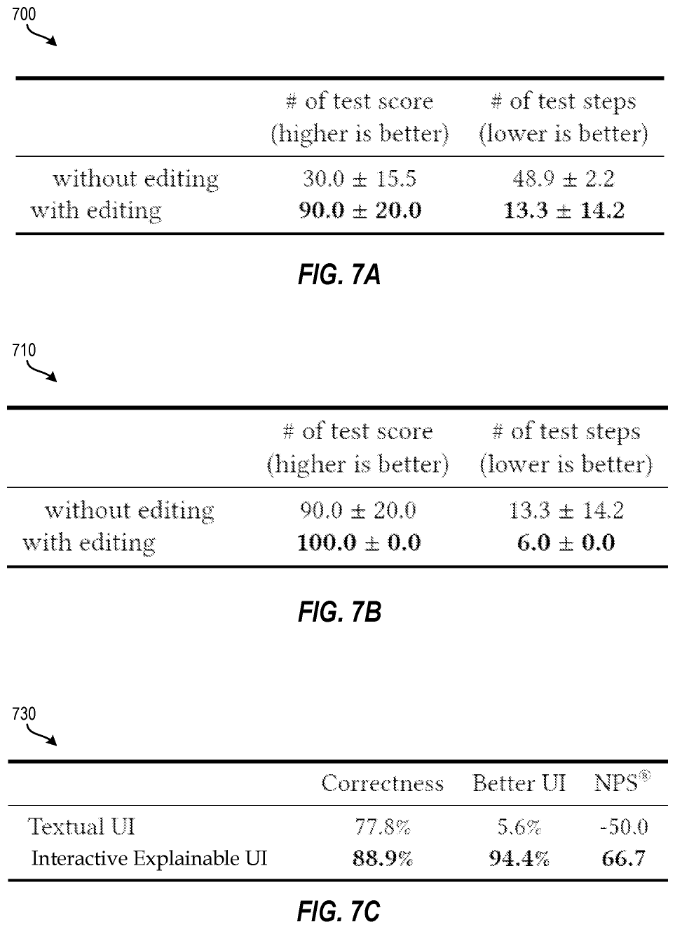

The evaluation for editing the network after training is now described. To make a trained network become an editable network (e.g., lead it to having useless predicates), the training data are biased by letting a container remain empty. The neuro-symbolic agent therefore trained the new rule “carry(x) Λ empty(y) Λ at_location(x, y)→insert(x, y)” instead of the normally trained rule “carry(x) Λ at_location(x, y)→insert(x, y).” A hypothesis that the human 208 can perceive “empty(y)” as an unnecessary predicate for the “insert” action when using the interactive explainable UI 500 of FIG. 5A is assumed. Test score values for a new obtained rule and a normal rule generated by deleting the “empty(y)” node using the editing function in the interactive explainable UI 500 (as shown in FIG. 6A) were measured. Table 700 of FIG. 7A shows a comparison between without/with editing the network after training. In this example, since the training data is biased, the trained network has an empty predicate initially, and this predicate is edited for the case of “with editing.”

In this example, the medium level in TWC was used and the reinforcement learning method from FOL-LNN was extended. As an example, the maximum steps for each episode was 50 (although other values could be used in other example); thus, the maximum number of test steps in the tables of FIGS. 7A, 7B, and 7C is 50. The total number of played game episodes during training was 80, 1×5 settings of game=5 games were used for extracting verb properties, and 15×5 settings of game=75 games were used for obtaining training samples. Each of these values were selected as an example only and should not be construed as limiting as other examples are also possible. The results in the table 700 were averaged over 5 random seeds as an example. As can be seen from the table 700, the score with editing was significantly higher than the score without editing; thus, the interactive explainable UI 500 is demonstrated to make the reinforcement learning score increase.

The evaluation for editing the network before training is now described. In this scenario, it can be assumed that the human 208 knows the predicate for a specific verb action. For example, the “at_location(x, y)” predicate is correlates with the “insert” action because “at_location(x, y)” states the place at which each object should be located. In this evaluation, the test score and number of steps for the case without any initial network (training from scratch) and the case with a small initial network are compared. The input “at_location(x, y)→insert(x, y)” is provided as the initial network (as shown in FIG. 6B). Both methods (without/with editing) performed a normal training process using the extension of the reinforcement learning method after setting the initial network, and the same parameters were used as the previous evaluation (editing after training). The table 710 of FIG. 7B shows a comparison table for training from scratch and training from the initial network. Since the score with the initial rule was higher (e.g., it reached the maximum value) than from scratch, the interactive explainable UI 500 is shown to boost training.

According to one or more embodiments described herein, a qualitative evaluation can be performed using a survey of users. The survey of questions can be presented to users to compare two user interfaces: a naïve textual UI that displays knowledge in contextual information (e.g., a portion of the neuro-symbolic agent selection field 406), and the interactive explainable UI 500 of FIGS. 5A-5E. As an example, the survey can include step-by-step guiding questions for controlling the agent, questions on the reason for each selected action, questions on choosing a preferable UI, and for rating a likelihood that the user would recommend one UI versus the other UI for measuring a net promotor score (NPS). Table 720 of FIG. 7C shows the results of such a survey, indicating the interactive explainable UI 500 outperformed the textual UI in correctness, being a better UI, and in NPS.

Example embodiments of the disclosure include or yield various technical features, technical effects, and/or improvements to technology. Example embodiments of the disclosure provide a system configured to explain neuro-symbolic reinforcement learning reasoning. These aspects of the disclosure constitute technical features that yield the technical effect of improving neuro-symbolic reinforcement learning models by providing a “human-in-the-loop” approach, where the reasoning behind rules of a trained model can be better understood and the model can be improved by editing (e.g., adding and/or removing) trained rules of the model. Accordingly, machine learning models are improved by providing higher test scores and lower test steps, as shown in FIGS. 7A and 7B, for example. It should be appreciated that the above examples of technical features, technical effects, and improvements to technology of example embodiments of the disclosure are merely illustrative and not exhaustive.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system comprising:
an action selector for selecting an action from possible candidates taken in an environment, wherein the action comprises a pair of a verb and an entity;
a current state fact visualizer for showing one or more logical facts that are extracted from natural observation sentences of the environment;
a contrastive external knowledge visualizer for visualizing contrastive information for a current state and a goal state which is from external knowledge; and
a trained rules analyzer for showing trained rules in a neuro-symbolic neural network for neuro-symbolic artificial intelligence,
wherein, in response to a first user selection of the action by using the action selector, the current state fact visualizer, the contrastive external knowledge visualizer, and the trained rules analyzer highlights each pair of the verb and the entity and a fired predicate corresponding to the first user selection.

2. The system of claim 1, wherein the neuro-symbolic neural network comprises a plurality of nodes and edges.

3. The system of claim 2, wherein, the trained rules analyzer presents the trained rules by using the plurality of nodes and edges.

4. The system of claim 3, wherein, responsive to a second user selection of a node or edge and an edit option, the neuro-symbolic neural network changes the neuro-symbolic neural network to change the trained rules.

5. The system of claim 1, wherein the trained rules analyzer enables a user to add a node to the neuro-symbolic neural network.

6. The system of claim 5, wherein adding a node to the neuro-symbolic neural network comprises:
receiving a selection of a predicate from multiple predicate candidates;
receiving an initiation of adding a node based on the selected verb and selected predicate;
and adding the node.

7. The system of claim 1, wherein the trained rules analyzer enables a user to delete a node from the neuro-symbolic neural network.

8. The system of claim 7, wherein deleting a node from the neuro-symbolic neural network comprises:
receiving a selection of a node to be deleted;
highlighting the selected node;
receiving an initiation of deletion of the selected node; and
deleting the selected node and any associated edges connected to the selected node.

9. A computer-implemented method comprising:
selecting an action from possible candidates taken in an environment, wherein the action comprises a pair of a verb and an entity;
displaying one or more logical facts that are extracted from natural observation sentences of the environment;
visualizing contrastive information for a current state and a goal state which is from external knowledge; and
displaying trained rules in a neuro-symbolic neural network for neuro-symbolic artificial intelligence,
wherein, in response to a first user selection of the action, highlighting each pair of the verb and the entity and a fired predicate corresponding to the first user selection.

10. The computer-implemented method of claim 9, wherein the neuro-symbolic neural network comprises a plurality of nodes and edges.

11. The computer-implemented method of claim 10, further comprising displaying the trained rules by using the plurality of nodes and edges.

12. The computer-implemented method of claim 11, wherein, responsive to a second user selection of a node or edge and an edit option, changing the neuro-symbolic neural network to change the trained rules.

13. The computer-implemented method of claim 9, further comprising adding a node to the neuro-symbolic neural network by:
receiving a selection of a predicate from multiple predicate candidates;
receiving an initiation of adding a node based on the selected verb and selected predicate;
and adding the node.

14. The computer-implemented method of claim 9, further comprising deleting a node from the neuro-symbolic neural network by:
receiving a selection of a node to be deleted;
highlighting the selected node;
receiving an initiation of deletion of the selected node; and
deleting the selected node and any associated edges connected to the selected node.

15. A computer program product comprising a computer readable storage medium having program instructions embodied therewith, the program instructions executable by a processor to cause the processor to perform operations comprising:
selecting an action from possible candidates taken in an environment, wherein the action comprises a pair of a verb and an entity;
displaying one or more logical facts that are extracted from natural observation sentences of the environment;
visualizing contrastive information for a current state and a goal state which is from external knowledge; and
displaying trained rules in a neuro-symbolic neural network for neuro-symbolic artificial intelligence,
wherein, in response to a first user selection of the action, highlighting each pair of the verb and the entity and a fired predicate corresponding to the first user selection.

16. The computer program product of claim 15, wherein the neuro-symbolic neural network comprises a plurality of nodes and edges.

17. The computer program product of claim 16, wherein the operations further comprise displaying the trained rules by using the plurality of nodes and edges.

18. The computer program product of claim 11, wherein, responsive to a second user selection of a node or edge and an edit option, wherein the operations further comprise changing the neuro-symbolic neural network to change the trained rules.

19. The computer program product of claim 15, wherein the operations further comprise adding a node to the neuro-symbolic neural network by:
receiving a selection of a predicate from multiple predicate candidates;
receiving an initiation of adding a node based on the selected verb and selected predicate;
and adding the node.

20. The computer program product of claim 15, wherein the operations further comprise deleting a node from the neuro-symbolic neural network by:
receiving a selection of a node to be deleted;
highlighting the selected node;
receiving an initiation of deletion of the selected node; and
deleting the selected node and any associated edges connected to the selected node.
